(19) United States
(12) Patent Application Publication
(10) Pub. No.: US 2024/0209289 A1
(43) Pub. Date: Jun. 27, 2024

(54) ACIDIC RINSE AID COMPOSITIONS AND METHODS OF USE THEREOF

(71) Applicant: ECOLAB USA INC., Saint Paul, MN (US)

(72) Inventors: Derrick Anderson, Saint Paul, MN (US); Erik C. Olson, Saint Paul, MN (US); Rosalind Haas, Saint Paul, MN (US)

(21) Appl. No.: 18/527,732

(22) Filed: Dec. 4, 2023

Related U.S. Application Data
(60) Provisional application No. 63/386,028, filed on Dec. 5, 2022.

(51) Int. Cl. C11D 3/20; C11D 3/04

(52) U.S. Cl. CPC C11D 3/2075; C11D 3/042; C11D 2111/14

(57) ABSTRACT

Methods for use of an acidic rinse aid for improved cleaning in a ware wash machine based on control of rinse pH to improve cleaning efficacy of the ware wash system are disclosed. The methods beneficially improve ware wash cleaning efficacy in combination with conventional alkaline detergent systems through generation of an acidic use pH in the rinse aid use solution. Acid rinse aid compositions for use in the methods are also disclosed.

### CROSS-REFERENCE TO RELATED APPLICATION

This application claims priority under 35 U.S.C. § 119 to Provisional Application U.S. Ser. No. 63/386,028, filed on Dec. 5, 2022, which is herein incorporated by reference in its entirety including without limitation, the specification, claims, and abstract, as well as any figures, tables, or examples thereof.

### TECHNICAL FIELD

The disclosure relates to rinse aids. In particular, the disclosure relates to methods for use of an acidic rinse aid for improved cleaning in a ware wash machine based on control of rinse pH to improve cleaning efficacy of the ware wash system. The methods of use beneficially improve ware wash cleaning efficacy in combination with conventional alkaline detergent systems. The present disclosure further relates to acid rinse aid compositions for use in the methods.

### BACKGROUND

Mechanical warewashing machines including dishwashers are commonly used around the world in both institutional and household environments. Such automatic warewashing machines clean dishes using two or more cycles, including initially a wash cycle followed by a rinse cycle. Such automatic warewashing machines can also utilize other cycles, for example, a soak cycle, a pre-wash cycle, a scrape cycle, additional wash cycles, additional rinse cycles, a sanitizing cycle, and/or a drying cycle. Any of these cycles can be repeated, if desired and additional cycles can be used. Rinse aids are conventionally used in warewashing applications to promote drying and to prevent the formation of spots on the ware being washed.

In order to reduce the formation of spotting, rinse agents have commonly been added to water to form an aqueous rinse that is sprayed on the dishware after cleaning is complete. Rinse aids, according to some mechanisms of action, form of a continuous sheet which drains evenly from the surface and minimizes the formation of spots. Rinse aids can further include enzymes and other components to aid in cleaning in addition to rinsing. However the primary focus of rinse aid technologies is to ensure a streak-free, spot-free and in some embodiments a fast-drying rinse step is achieved.

A number of rinse aids are currently known, each having certain advantages and disadvantages. There is an ongoing need for alternative rinse aid compositions, especially alternative rinse aid compositions that are environmentally friendly (e.g., biodegradable), and that essentially include components that are suitable for use in food service industries, e.g. GRAS ingredients (generally recognized as safe by the USFDA, partial listing available at 21 C.F.R. §§ 184).

It is therefore an object of this disclosure to provide methods for rinsing a surface with a rinse aid composition that impart additional cleaning efficacy and performance.

It is a further object of the disclosure to provide methods for rinsing a surface with a rinse aid composition that provide a use pH less than about 6, or preferably less than about 5.5 to neutralize and convert carbonate alkalinity into carbonic acid for additional cleaning efficacy and performance in the rinsing step.

It is another object of this disclosure to formulate acidic rinse aid compositions for dosing into a warewash machine to provide a use pH less than about 6, or preferably less than about 5.5 to neutralize and convert carbonate alkalinity into carbonic acid for additional cleaning efficacy and performance in the rinsing step.

Moreover, the methods and compositions provide rinsing that is compatible with caustic detergent, carbonate detergent, enzymatic detergent or combinations thereof, without negatively interfering with drying time, surface tension or other conventional rinse aid performance metrics.

Additional objects, advantages and features of the present invention will become apparent from the following specification taken in conjunction with the accompanying drawings.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

According to some aspects of the present disclosure, methods of rinsing a surface with a rinse aid composition comprise: providing an acidic rinse aid composition to a surface, wherein the acidic rinse aid composition comprises at least one acid source, at least one rinse aid surfactant, and at least one solidification aid and/or water, wherein the composition is a solid or liquid; and rinsing said acidic rinse aid composition from said surface, wherein said acidic rinse aid composition has a use solution pH less than about 6 and provides cleaning efficacy on the surface.

According to some additional aspects of the present disclosure, an acidic rinse aid composition comprises at least one acid source; at least one rinse aid surfactant; and at least one solidification aid and/or water, wherein the composition is a solid or liquid.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows tile samples dyed with Coomassie blue stain to visually indicate cleaning performance according to a visual rating scale as described in Example 1.

FIG. 2 shows a graph of pH measured as varying concentrations of acidic rinse aid compositions are added into two water sources (5 gpg, 17 gpg).

FIG. 3 shows a citric acid pH curve graph for 5 gpg water (as depicted in FIG. 1) with corresponding tile samples demonstrating cleaning efficacy of the evaluated acidic rinse aid compositions as described in Example 1.

FIGS. 4A-4G show tile samples from FIG. 3 demonstrating cleaning efficacy of the evaluated acidic rinse aid compositions.

FIG. 5 shows glass ware cleaned with the acidic rinse aid compositions in a 100 cycle cleaning test as described in Example 2.

FIG. 6 shows a graph of pH measured as varying concentrations of acidic rinse aid compositions are added into two water sources (5 gpg, 17 gpg).

FIG. 7 shows a formic acid pH curve graph for 5 gpg water (as depicted in FIG. 6) with corresponding tile samples demonstrating cleaning efficacy of the evaluated acidic rinse aid compositions as described in Example 3.

FIGS. 8A-8G show tile samples from FIG. 7 demonstrating cleaning efficacy of the evaluated acidic rinse aid compositions.

FIGS. 9A-9B show tile samples demonstrating cleaning efficacy of the evaluated acidic rinse aid compositions compared to a neutral rinse aid composition as described in Example 4.

FIG. 10 shows a graph demonstrating rinse dry time of the acidic rinse aid compositions as described in Example 5.

FIG. 11 shows plate samples demonstrating cleaning efficacy of the evaluated acidic rinse aid compositions in combination with a caustic detergent in 5 gpg water compared to a neutral rinse aid composition in combination with a caustic .

FIG. 12 shows plate samples demonstrating cleaning efficacy of the evaluated acidic rinse aid compositions in combination with a caustic detergent in 0-1 gpg water compared to a caustic only detergent as described in Example 7.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that rinse aid methods that utilize acidic rinse aid compositions to decrease the pH in the use solution in the ware wash machine provide improved cleaning in the rinse aid step.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include cach integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, c.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, surface tension, molecular weight, contact angle, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

An “anti-redeposition agent” refers to a compound that helps keep suspended in water instead of redepositing onto the object being cleaned. Anti-redeposition agents are useful in the present invention to assist in reducing redepositing of the removed soil onto the surface being cleaned.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (c.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The term “generally” encompasses both “about” and “substantially.”

The term “generally recognized as safe” or “GRAS,” as used herein refers to components classified by the Food and Drug Administration as safe for direct human food consumption or as an ingredient based upon current good manufacturing practice conditions of use, as defined for example in 21 C.F.R. Chapter 1, § 170.38 and/or 570.38.

The term “hard surface” refers to a solid, substantially non-flexible surface such as a counter top, tile, floor, wall, panel, window, plumbing fixture, kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the term “phosphorus-free” or “substantially phosphorus-free” refers to a composition, mixture, or ingredient that does not contain phosphorus or a phosphorus-containing compound or to which phosphorus or a phosphorus-containing compound has not been added. Should phosphorus or a phosphorus-containing compound be present through contamination of a phosphorus-free composition, mixture, or ingredients, the amount of phosphorus shall be less than 0.5 wt. %. More preferably, the amount of phosphorus is less than 0.1 wt. %, and most preferably the amount of phosphorus is less than 0.01 wt. %.

As used herein, the term “polymer” generally includes, but is not limited to, homopolymers, copolymers, such as for example, block, graft, random and alternating copolymers, terpolymers, and higher “x”mers, further including their derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

As used herein, the term “sulfate-free” or “substantially sulfate-free” refers to a composition, mixture, or ingredient that does not contain sulfate or a sulfate-containing compound, such as a sulfated surfactant, or to which sulfate or a sulfate-containing compound has not been added. Should sulfate or a sulfate-containing compound be present through contamination of a sulfate-free composition, mixture, or ingredients, the amount of phosphorus shall be less than 1 wt. %, preferably less than 0.5 wt. %, more preferably less than 0.3 wt. %, and most preferably less than 0.1 wt. %.

The term “surfactant” or “surface active agent” refers to an organic chemical that when added to a liquid changes the properties of that liquid at a surface.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “water conditioning agent” refers to a compound that inhibits crystallization of water hardness ions from solution or disperses mineral scale including but not limited to calcium carbonate. Water conditioning agents include but are not limited to polyacrylic acids, polymethacrylic acids, olefin/maleic copolymers, polyacrylate alkali metal salts, polymethacrylate alkali metal salts and olefin/maleate alkali metal salts and the like.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Methods of Using Acidic Rinse Aid Compositions

Commercial warewashing machines have two general types of rinse cycles. A first type of rinse cycle can be referred to as a hot water sanitizing rinse cycle because of the use of generally hot rinse water (about 180° F.). A second type of rinse cycle can be referred to as a chemical sanitizing rinse cycle and it uses generally lower temperature rinse water (about 120° F.). The methods of using the acidic rinse aid compositions can be used in either type of rinse cycle.

The methods of using the acidic rinse aid compositions include applying the compositions to ware in a warewashing machine. The rinse aid composition can be dispensed as a solid concentrate and diluted to a use solution, dispensed as a liquid concentrate and diluted to a use solution, or dispensed as a use solution. In general, it is expected that a solid or liquid concentrate will be dissolved (for a solid) and diluted with water to provide the use solution that is then applied to the substrate surface to be cleaned and rinsed within the warewashing machine.

The use solution can be applied to the substrate during a rinse application, for example, during a rinse cycle, for example, in a warewashing machine, or the like. In some embodiments, formation of a use solution can occur from a rinse composition installed in a cleaning machine, for example onto a dish rack. The rinse agent can be diluted and dispensed from a dispenser mounted on or in the machine or from a separate dispenser that is mounted separately but cooperatively with the dish machine. For example, in some embodiments, liquid rinse aid compositions can be dispensed by incorporating compatible packaging containing the liquid material into a dispenser adapted to diluting the liquid with water to a final use concentration. Some examples of dispensers for the liquid rinse agent of the invention are DRYMASTER-P sold by Ecolab Inc.

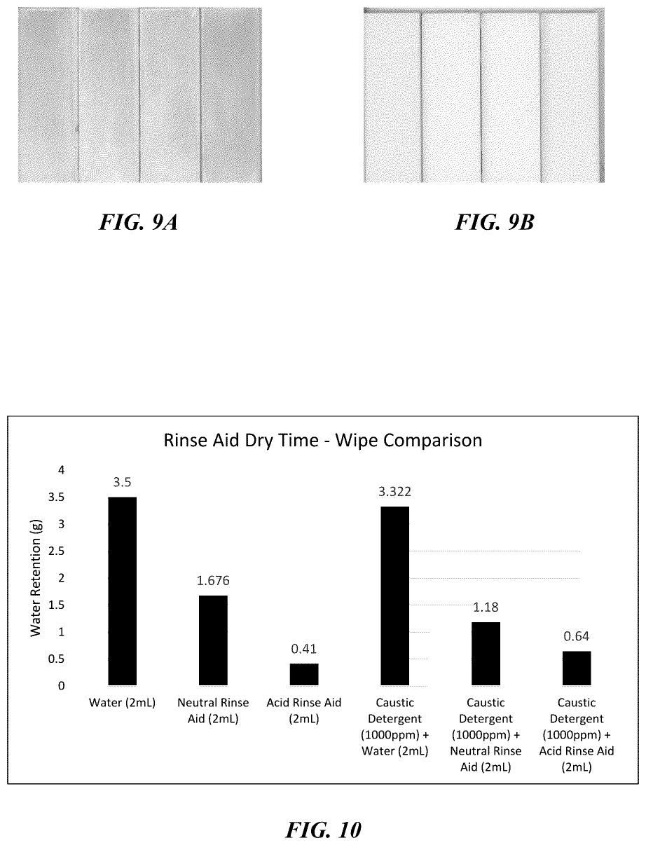

In other example embodiments, solid products, such as cast or extruded solid rinse aid compositions, may be conveniently dispensed by inserting a solid material in a container or with no enclosure into a spray-type dispenser such as the volume SOL-ET controlled ECOTEMP Rinse Injection Cylinder system manufactured by Ecolab Inc. Such a dispenser cooperates with a warewashing machine in the rinse cycle. When demanded by the machine, the dispenser directs a spray of water onto the cast solid block of rinse agent which effectively dissolves a portion of the block creating a concentrated aqueous rinse solution which is then fed directly into the rinse water forming the aqueous rinse. The aqueous rinse is then contacted with the dishes to affect a complete rinse. This dispenser and other similar dispensers are capable of controlling the effective concentration of the active portion in the aqueous rinse by measuring the volume of material dispensed, the actual concentration of the material in the rinse water (an electrolyte measured with an electrode) or by measuring the time of the spray on the cast block. In general, the concentration of active portion in the aqueous rinse is preferably the same as identified above for liquid rinse agents. Some other embodiments of spray-type dispenser are disclosed in U.S. Pat. Nos. 4,826,661, 4,690,305, 4,687,121, and 4,426,362 and in U.S. Pat. Nos. Re 32,763 and 32,818, the disclosures of which are incorporated by reference herein. An example of a particular product shape is shown in FIG. 9 of U.S. Pat. No. 6,258,765, which is incorporated herein by reference.

In some embodiments, the acidic rinse aid composition can be used in a variety of water environments, including hard or soft water, or a high solids containing water environment in order to reduce the appearance of a visible film caused by the level of dissolved solids provided in the water. In general, high solids containing water is considered to be water having a total dissolved solids (TDS) content in excess of 200 ppm. In certain localities, the service water contains total dissolved solids content in excess of 400 ppm, and even in excess of 800 ppm.

Exemplary substrates or articles in the warewashing industry that can be treated with an acidic rinse aid composition include dishware, cups, glasses, flatware, and cookware. For the purposes of this invention, the terms “dish” and “ware” are used in the broadest sense to refer to various types of articles used in the preparation, serving, consumption, and disposal of food stuffs including pots, pans, trays, pitchers, bowls, plates, saucers, cups, glasses, forks, knives, spoons, spatulas, and other glass, metal, ceramic, plastic composite articles commonly available in the institutional or household kitchen or dining room. In general, these types of articles can be referred to as food or beverage contacting articles because they have surfaces which are provided for contacting food and/or beverage. When used in these warewashing applications, the rinse aid composition should provide effective sheeting action and low foaming properties. In addition to having the desirable properties described above, it may also be useful for the rinse aid to be biodegradable, environmentally friendly, and generally nontoxic. A rinse aid of this type may be described as being “food grade.”

The acidic rinse aid compositions are in contact with a surface for a sufficient amount of time to clean and rinse the surface. In an aspect, the surface is contacted with the acidic rinse aid composition for at least a few seconds to at least about 1 minute, or greater in the warewashing machine.

The acidic rinse aid compositions are applied at a use solution pH that is less than about 6 pH, or preferably less than about 5.5. Without being limited to a particular mechanism of action, the carbonate in water (CO₂, natural alkalinity) is in equilibrium with H₂CO₃ in very acidic, or low pH, environments of less than about 4 pH. At approximately 4 pH, the percentage of HCO₃⁻ species grows with increasing pH, and reaches equilibrium with the H₂CO₃ species at a pH of about 6.4,. At a pH of 8, the HCO₃⁻ species is the dominant species found in the water, and minimal CO₂ or H₂CO₃ is found. Similarly, at approximately 8 pH, CO₃²⁻ species grows and reaches equilibrium with the HCO₃⁻ species at a pH of about 10.2, and becomes the dominant species found in water at pH levels of about 12 or more. Thus, it is generally thought that neutralizing the HCO₃⁻ species aids in cleaning and help eliminate hardwater spots at a pH that is less than about 6.4 pH, preferably less than about 6 pH, or more preferably less than about 5.5 pH, and further beneficially aids in full cleaning cycle during the rinse step.

The methods can include a first step of generating a use solution of the acidic rinse aid composition. The use solution can be generated in a warewashing machine from either a solid or liquid acidic rinse aid composition. The addition of the rinse aid use solution follows a cleaning step in the warewashing machine. The cleaning step can comprise a caustic detergent, carbonate detergent, silicate detergent, tripoly detergent, enzymatic detergent or combinations thereof. Beneficially, the methods of rinsing are compatibility with conventional cleaning steps, including alkaline detergent cleaning steps.

The use concentration of the acidic rinse aid composition is secondary to the pH of the use composition. The method is a pH-driving instead of a concentration driven response. However, in some embodiments and dependent upon the water source used in the warewashing machine and the acid source in the rinse aid composition, a concentration range of at least about 50 ppm, at least about 100 ppm, at least about 150 ppm, at least about 200 ppm, at least about 250 ppm, or at least about 300 ppm acidic rinse aid composition is employed to provide the cleaning and rinsing.

### Compositions

According to embodiments, the acidic rinse aid compositions include at least one acid source (organic and/or inorganic) and at least one rinse aid surfactant. The acidic rinse aid compositions can include additional functional ingredients and can be provided as concentrate or use compositions. Exemplary acidic rinse aid compositions are shown in Table 1 in weight percentage. While the components may have a percent actives of 100%, it is noted that Table 1 does not recite the percent actives of the components, but rather, recites the total weight percentage of the raw materials (i.e. active concentration plus inert ingredients).

TABLE 1

| | First | Second | Third |
|---|---|---|---|
| | Exemplary | Exemplary | Exemplary |
| Material | Range wt.-% | Range wt.-% | Range wt.-% |
| Acid source | 1-90 | 10-90 | 10-80 |
| Surfactant(s) | 1-50 | 5-40 | 5-20 |
| Additional Functional | 0-90 | 0-75 | 0-50 |
| Ingredients | | | |

### Acid Source

The acidic rinse aid compositions comprises one or more acid sources. The acid source can be any acid source that is compatible with the other components of the acidic rinse aid composition and provides suitability use pH for the ware washing methods described herein. Exemplary acid sources include organic and inorganic acids. Exemplary acid sources include liquid and solid acids.

Suitable organic acids include acids with the strongest pKa of about 5 or below. Preferred organic acids include citric, lactic, acetic, formic, and hydroxyacetic acid.

Hydroxycarboxylic acids or salt of thereof can be included. Suitable hydroxycarboxylic acids and their salts for use in acidic rinse aid compositions, namely solid rinse aid compositions include, citric, lactic, gluconic and acetic acids and combinations and/or alkali metal salts thereof. The hydroxycarboxylic acids or alkali metal salts thereof may be added to or be present in the composition in either the anhydrous or hydrated form or combinations thereof.

In some embodiments, the acid source(s) is included in the acidic rinse aid composition at an amount of at least about 1 wt-% to about 90 wt-%, about 10 wt-% to about 90 wt-%, about 10 wt-% to about 80 wt-%, about 10 wt-% to about 70 wt-%, about 10 wt-% to about 60 wt-%, or about 20 wt-% to about 60 wt-%. In embodiments the acid source(s) provide a use solution pH less than about 6, or less than about 5.5. In addition, without being limited according to the disclosure, all ranges recited are inclusive of the numbers defining the range and include each integer within the defined range.

### Surfactants

The acidic rinse aid compositions comprises one or more surfactants suitable for rinse aid applications. In embodiments, the surfactant acts as a sheeting agent. Rinse aid surfactants can include one or more alcohol ethoxylate compounds, alcohol alkoxylate compound, polyether compounds, block polyoxypropylene-polyoxyethylene polymeric compounds, alkylpoly glucosides, additional nonionic surfactants and/or polymer surfactants, or combinations thereof.

Suitable alcohol ethoxylate compounds include an alkyl group that has 20 or fewer carbon atoms. Typically, the blend of one or more alcohol ethoxylate compounds in the shecting agent is a solid at room temperature, for example by having a melting point equal to or greater than 100° F., often greater than 110° F., and frequently in the range of 110° F. to 120° F. In at least some embodiments, alcohol ethoxylate compounds may cach independently have structure represented by Formula I: R—O—(CH₂CH₂O)ₙ—H (I), wherein R is a linear or branched (C₁-C₁₈) alkyl group and n is an integer in the range of 1 to 100. In some embodiments, R may be a linear or branched (C₈-C₁₅) alkyl group, or may be a (C₈-C₁₀) alkyl group. Similarly, in some embodiments, n is an integer in the range of 1 to 50, or in the range of 1 to 35, or in the range of 1 to 25. In some embodiments, the one or more alcohol ethoxylate compounds are straight chain hydrophobes.

In at least some embodiments, the alcohol ethoxylate compounds include at least two different alcohol ethoxylate compounds cach having structure represented by Formula I. In other words, the R and/or n variables of Formula I, or both, may be different in the two or more different alcohol ethoxylate compounds present in the sheeting agent. For example, the surfactants may include a first alcohol ethoxylate compound in which R is a linear or branched (C₈-C₁₀) alkyl group, and a second alcohol ethoxylate compound in which R is a linear or branched (C₁₀-C₁₂) alkyl group.

In some embodiments where, for example, at least two different alcohol ethoxylate compounds are included, the ratio of the different alcohol ethoxylate compounds can be varied to achieve the desired characteristics of the final composition. For example, in some embodiments including a first alcohol ethoxylate compound and a second alcohol ethoxylate compound, the ratio of weight-percent first alcohol ethoxylate compound to weight-percent second compound may be in the range of about 1:1 to about 10:1 or more. Similarly, the range of mole ratio of the first compound to the second compound may be about 1:1 to about 10:1, and in some embodiments, in the range of about 3:1 to about 9:1.

In some embodiments, the alcohol ethoxylates can be chosen such that they have certain characteristics, for example, are environmentally friendly, are suitable for use in food service industries, and/or the like. For example, the particular alcohol ethoxylates used in the shecting agent may meet environmental or food service regulatory requirements, for example, biodegradability requirements.

Some specific examples of suitable alcohol ethoxylate combinations including a first alcohol ethoxylate wherein R is a linear or branched C₁₀ alkyl group and n is 21 (i.e. 21 moles ethylene oxide) and a second alcohol ethoxylate wherein R is a C₁₂ alkyl group and again, n is 21 (i.e. 21 moles ethylene oxide). Such a combination can be referred to as an alcohol ethoxylate C₁₀₋₁₂, 21 moles EO. In some particular embodiments, the sheeting agent may include in the range of about 85 wt. % or more of the Cio alcohol ethoxylate and about 15 wt. % or less of the C₁₂ alcohol ethoxylate. For example, the sheeting agent may include in the range of about 90 wt. % of the Cio alcohol ethoxylate and about 10 wt. % of the C₁₂ alcohol ethoxylate. One example of such an alcohol ethoxylate mixture is commercially available from Sasol under the trade name NOVEL II 1012-21. Alcohol ethoxylate surfactants are also described in U.S. Pat. No. 7,279,455, assigned to Ecolab, herein incorporated by reference.

Suitable polyether compounds include compounds prepared from ethylene oxide, propylene oxide, or a mixture in a homopolymer or block or hetero-copolymer structure. Such polyether compounds are known as polyalkylene oxide polymers, polyoxyalkylene polymers or polyalkylene glycol polymers. Such sheeting agents require a region of relative hydrophobicity and a region of relative hydrophilicity to provide surfactant properties to the molecule. Such sheeting agents can have a molecular weight in the range of about 500 to 15,000. Certain types of (PO)(EO) polymeric rinse aids have been found to be useful containing at least one block of poly(PO) and at least one block of poly(EO) in the polymer molecule. Additional blocks of poly(EO), poly (PO) or random polymerized regions can be formed in the molecule. Particularly useful polyoxypropylene polyoxyethylene block copolymers are those comprising a center block of polyoxypropylene units and blocks of polyoxyethylene units to each side of the center block. Such polymers have the formula shown below: (EO)ₙ-(PO)ₘ-(EO)ₙ. wherein m is an integer of 20 to 60, and each end is independently an integer of 10 to 130. Another useful block copolymer are block copolymers having a center block of polyoxyethylene units and blocks of polyoxypropylene to each side of the center block. Such copolymers have the formula: (PO)ₙ-(EO)ₘ-(PO)ₙ. wherein m is an integer of 15 to 175, and each end are independently integers of about 10 to 30. For solid compositions, a hydrotrope may be used to aid in maintaining the solubility of sheeting or wetting agents. Hydrotropes can be used to modify the aqueous solution creating increased solubility for the organic material. In some embodiments, hydrotropes are low molecular weight aromatic sulfonate materials such as xylene sulfonates and dialkyldiphenyl oxide sulfonate materials.

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful nonionic surfactants include:

Block polyoxypropylene-polyoxyethylene polymeric compounds based upon propylene glycol, ethylene glycol, glycerol, trimethylolpropane, and ethylenediamine as the initiator reactive hydrogen compound (1). Examples of polymeric compounds made from a sequential propoxylation and ethoxylation of initiator are commercially available from BASF Corp. One class of compounds is difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-flinctional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide (2). The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igcpal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide (3). The alcohol moiety can consist of mixtures of alcohols in the above delineated carbon range or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide (4). The acid moiety can consist of mixtures of acids in the above defined carbon atoms range or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Care must be exercised when adding these fatty ester or acylated carbohydrates to compositions of the present invention containing amylase and/or lipase enzymes because of potential incompatibility.

Examples of nonionic low foaming surfactants include:

Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959 to Brown et al. and represented by the formula

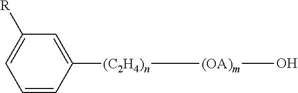

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z}, wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R2CON_{R1}Z in which: R1 is H, C₁-C₄ hydrocarbyl, 2-hydroxy cthyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a lincar hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or --(C₂H₄O)ₓH, where x is in the range of from 1 to 3.

A useful class of non-ionic surfactants includes the class defined as alkoxylated amines or, most particularly, alcohol alkoxylated/aminated/alkoxylated surfactants. These non-ionic surfactants may be at least in part represented by the general formulae: R²⁰--(PO)_{S}N--(EO)ₜH, R²⁰--(PO)_{S}N--(EO)ₜH(EO)ₜH, and R²⁰--N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰--(PO)_{V}--N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Preferred nonionic surfactants for the compositions of the invention include alcohol alkoxylates, EO/PO block copolymers, alkylphenol alkoxylates, and the like.

In additional embodiments, nonionic surfactants can have the following general formula: R₁-(A)ₓ-(B)_{y1}-(A)_{z}-(B)_{y2}-R₂, wherein:
R₁ and R₂ independently denote H or linear or branched, substituted or unsubstituted C1-C22 alkyl,
A denotes CH₂—CH₂—O,
B denotes CH₂—CHR₃—O, wherein R₃ denotes H or linear or branched, unsubstituted C1-C10 alkyl,
x is an integer in the range from 0 to 35,
y₁ is an integer in the range from 0 to 60,
y₂ is an integer in the range from 0 to 35, and
z is an integer in the range from 0 to 35, and
wherein the sum of x+y₁+z+y₂ is at least 1.

In exemplary embodiments the sum of x+y₁+z+y₂ is in the range of 1 to 100, more preferably the sum of x+y₁+z+y₂ is in the range of 1 to 75 even more preferably the sum of x+y₁+z+y₂ is in the range of 2 to 75 and most preferably the sum of x+y +z+y2 is in the range of 2 to 70.

In an embodiment, as referring to the nonionic surfactant R₁-(A)ₓ-(B)_{y1}-(A)_{z}-(B)_{y2}-R₂, the term “alkyl,” as used herein, refers to acyclic saturated aliphatic residues, including linear or branched alkyl residues. Furthermore, the alkyl residue is preferably unsubstituted and includes as in the case of C₁-C₂₂ alkyl 1 to 22 carbon atoms. Furthermore, “branched” denotes a chain of atoms with one or more side chains attached to it. Branching occurs by the replacement of a substituent, e.g., a hydrogen atom, with a covalently bonded aliphatic moiety. In embodiments, representative examples of linear and branched, unsubstituted C₁-C₂₂ alkyl include, but are not limited to methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-hepta-decyl, n-octadecyl, n-nonadecyl, n-eicosyl, n-heneicosyl, n-docosyl, isopropyl, isobutyl, iso-pentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoe-icosyl, isoheneicosyl, isodocosyl, 2-propyl heptyl, 2-ethyl hexyl and t-butyl.

Additional disclosure of various suitable nonionic surfactants is set forth in U.S. Publication No. 2021/0071108. The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present invention. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

In some embodiments, the surfactant(s) is included in the acidic rinse aid composition at an amount of at least about 1 wt-% to about 50 wt-%, about 2 wt-% to about 50 wt-%, about 5 wt-% to about 50 wt-%, about 5 wt-% to about 40 wt-%, about 5wt-% to about 30 wt-%, or about 5 wt-% to about 20 wt-%. In addition, without being limited according to the disclosure, all ranges recited are inclusive of the numbers defining the range and include each integer within the defined range.

### Water

The acidic rinse aid compositions can include water. Water can be independently added to the acidic rinse aid composition or can be provided in the acidic rinse aid composition as a result of its presence in an aqueous material that is added to the compositions. For example, for solid compositions materials added to the rinse aid composition include water or can be prepared in an aqueous premix available for reaction with the solidification agent component(s). Water introduced in the rinse aid composition during formation of the rinse aid composition can be removed or become water of hydration. Typically, water is introduced into the rinse aid composition to provide the detergent composition with a desired viscosity prior to solidification, and/or to provide a desired rate of solidification, and/or as a processing aid. The components used to form the solid composition can include water as hydrates or hydrated forms of the solidification agent, hydrates or hydrated forms of any of the other ingredients, and/or added aqueous medium as an aid in processing. It is expected that the aqueous medium will help provide the components with a desired viscosity for processing. In addition, it is expected that the aqueous medium may help in the solidification process when forming the solid rinse aid compositions.

In embodiments of the liquid compositions, water is independently added to the acidic rinse aid compositions. In some embodiments, water is included in a liquid acidic rinse aid composition at an amount of at least about 5 wt-% to about 80 wt-%, about 10 wt-% to about 80 wt-%, about 15 wt-% to about 80 wt-%, about 10 wt-% to about 70 wt-%, about 15 wt-% to about 70 wt-%, or about 15 wt-% to about 60 wt-%. In addition, without being limited according to the disclosure, all ranges recited are inclusive of the numbers defining the range and include cach integer within the defined range.

### Solidification Aid

In some embodiments, one or more solidification agents may be included in the solid acidic rinse aid composition. Solidification aids can include hardening agents. Examples of hardening agents include urea, an amide such stearic monocthanolamide or lauric diethanolamide, or an alkylamide, and the like; sulfate salts or sulfated surfactants, and aromatic sulfonates, and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the rinse aid and/or other active ingredients may be dispensed from the solid composition over an extended period of time.

Suitable aromatic sulfonates include, but are not limited to, sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and/or sodium butyl naphthalene. Preferred aromatic sulfonates include sodium xylene sulfonate and sodium cumene sulfonate.

The amount of solidification agent included in an acidic rinse aid composition can be dictated by the desired effect. In general, an effective amount of solidification agent is considered an amount that acts with or without other materials to solidify the rinse aid composition. In embodiments seeking only to modify the viscosity and not solidify the rinse aid composition, an effective amount is considered an amount that acts with or without other materials to achieve the desired viscosity. Typically, for solid embodiments, the amount of solidification agent in a solid rinse aid composition is from about 10 to about 80 wt-%, from about 20 to about 75 wt-%, from about 20 to about 70 wt-%, or from about 20 to about 50 wt-% of the composition. In addition, without being limited according to the disclosure, all ranges recited are inclusive of the numbers defining the range and include each integer within the defined range.

In some embodiments, it is desirable for the solidification agents to be substantially free of sulfate. For example, the rinse aid may have less than 1 wt-% sulfate, preferably less than 0.5 wt-%, more preferably less than 0.1 wt-%. In a preferred embodiment the rinse aid is free of sulfate.

In certain embodiments it can be desirable to have a secondary solidification agent. In compositions containing secondary solidification the composition may include a secondary solidification agent in an amount in the range of up to about 30 wt-%, from about 5 to about 25 wt-%, from about 10 to about 25 wt-%, or from about 5 to about 15 wt .- %. In addition, without being limited according to the disclosure, all ranges recited are inclusive of the numbers defining the range and include each integer within the defined range.

The solidification process can last from a few minutes to about four hours, depending, for example, on the size of the cast, extruded or pressed composition, the ingredients of the composition, the temperature of the composition, and other like factors. Typically, the rinse aid composition of the present disclosure exhibits extended mix time capability. Often, the cast, extruded or pressed composition “sets up” or begins to harden to a solid form within 1 minute to about 3 hours. For example, the cast or extruded composition “sets up” or begins to harden to a solid form within a range of 1 minute to 2 hours. In some instances, the cast or extruded composition “sets up” or begins to harden to a solid form with a range of 1 minute to about 20 minutes.

### Additional Functional Ingredients

The components of the acidic rinse aid composition can further be combined with various functional components suitable for uses disclosed herein. In some embodiments, the acidic rinse aid compositions including the acid source and rinse aid surfactant make up a large amount, or even substantially all of the total weight of the acidic rinse aid composition. Depending upon the liquid or solid state of the composition, water and/or solidification agents or hardening agents can be included in the acidic rinse aid compositions. For example, in some embodiments few or no additional functional ingredients are disposed therein.

In some embodiments, the compositions are free of zinc and/or zinc salts. In some embodiments, the compositions are free of zinc, zinc salts and/or additional anti-etch functional ingredients.

In other embodiments, additional functional ingredients may be included in the acidic rinse aid composition. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the acidic rinse aid compositions may include defoamers, anti-redeposition agents, preservatives, water conditioning polymers, solubility modifiers, dispersants, metal protecting agents, stabilizing agents, humectants, sanitizing agents, anti-microbial agents, chelants, aesthetic enhancing agents, solubility modifiers, hydrotropes or couplers, buffers, solvents, additional cleaning agents and the like.

These additional ingredients can be pre-formulated with the acidic rinse aid compositions or added to the use solution before, after, or substantially simultaneously with the addition of the compositions.

According to embodiments of the disclosure, the various additional functional ingredients may be provided in a composition in the amount from about 0 wt-% and about 90 wt-%, from about 0 wt-% and about 75 wt-%, from about 0 wt-% and about 50 wt-%, from about 0.01 wt-% and about 50 wt-%, from about 0.1 wt-% and about 50 wt-%, from about 1 wt-% and about 50 wt-%, from about 1 wt-% and about 40 wt-%, from about 1 wt-% and about 30 wt-%, or from about 1 wt-% and about 20 wt-%. In addition, without being limited according to the disclosure, all ranges recited are inclusive of the numbers defining the range and include each integer within the defined range.

### Defoamers

The acidic rinse aid composition can also include an effective amount of defoamer, e.g. configured for reducing the stability of foam that may be created by certain rinse aid surfactants including alcohol ethoxylates in an aqueous solution. Any of a broad variety of suitable defoamers may be used, for example, any of a broad variety of nonionic ethylene oxide (EO) containing surfactants. Many nonionic ethylene oxide derivative surfactants are water soluble and have cloud points below the intended use temperature of the rinse aid composition, and therefore may be useful defoaming agents. In addition, where the solid rinse aid composition is preferred to be biodegradable, the defoamers are also selected to be biodegradable.

Some examples of ethylene oxide derivative surfactants that may be used as defoamers include polyoxyethylene-polyoxypropylene block copolymers, alcohol alkoxylates, low molecular weight EO containing surfactants, or the like, or derivatives thereof. Some examples of polyoxyethylene-polyoxypropylene block copolymers include those having the following formulae:

(EO)ₓ(PO)_{y}(EO)ₓ

(PO)_{y}(EO)ₓ(PO)_{y}

(PO)_{y}(EO)ₓ(PO)_{y}(EO)ₓ(PO)_{y}

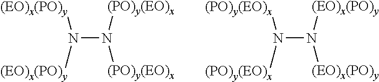

wherein EO represents an ethylene oxide group, PO represents a propylene oxide group, and x and y reflect the average molecular proportion of each alkylene oxide monomer in the overall block copolymer composition. In some embodiments, x is in the range of about 1 to about 130, y is in the range of about 5 to about 70, and x plus y is in the range of about 5 to about 200. It should be understood that each x and y in a molecule can be different. In some embodiments, the total polyoxyethylene component of the block copolymer can be in the range of at least about 20 mol-% of the block copolymer and in some embodiments, in the range of at least about 30 mol-% of the block copolymer. In some embodiments, the material can have a molecular weight greater than about 400, and in some embodiments, greater than about 500. For example, in some embodiments, the material can have a molecular weight in the range of about 500 to about 7000 or more, or in the range of about 950 to about 4000 or more, or in the range of about 1000 to about 3100 or more, or in the range of about 2100 to about 6700 or more.

Although the exemplary polyoxyethylene-polyoxypropylene block copolymer structures provided above have 3-8 blocks, it should be appreciated that the nonionic block copolymer surfactants can include more or less than 3-8 blocks. In addition, the nonionic block copolymer surfactants can include additional repeating units such as butylene oxide repeating units. Furthermore, the nonionic block copolymer surfactants that can be used according to the invention can be characterized hetero-polyoxyethylene-polyoxypropylene block copolymers. Some examples of suitable block copolymer surfactants include commercial products such as PLURONIC® and TETRONIC® surfactants, commercially available from BASF. For example, PLURONIC® 25-R4 is one example of a useful block copolymer surfactant commercially available from BASF, that is biodegradable and GRAS.

In some embodiments, the defoamer component can comprise in the range of about 1 to about 60 wt-%, about 5 to about 50 wt-%, or about 10 to about 35 wt-% of the total composition. In addition, without being limited according to the disclosure, all ranges recited are inclusive of the numbers defining the range and include each integer within the defined range.

The amount of defoamer component present in the composition can also be dependent upon the amount of rinse aid surfactants, namely sheeting agent surfactants present in the composition. For example, the less sheeting agent present in the composition may provide for the use of less defoamer component. In some example embodiments, the ratio of weight-percent sheeting agent component to weight-percent defoamer component may be in the range of about 1:5 to about 5:1, or in the range of about 1:3 to about 3:1. Those of skill in the art will recognize that the ratio of sheeting agent component to defoamer component may be dependent on the properties of either and/or both actual components used, and these ratios may vary from the example ranges given to achieve the desired defoaming effect. Defoamer components are also described in U.S. Pat. No. 7,279,455, assigned to Ecolab, herein incorporated by reference.

### Water Conditioning Polymers

The acidic rinse aid compositions can include a water conditioning polymer. An example of a suitable water conditioning polymer includes polyacrylic acid homopolymer or alkali metal salt thereof, i.e., sodium polyacrylate. The polyacrylic acid homopolymers can contains a polymerization unit derived from the monomer selected from the group consisting of acrylic acid, methacrylic acid, methyl acrylate, methyl methacrylate, ethyl acrylate, ethyl methacrylate, butyl acrylate, butyl methacrylate, iso-butyl acrylate, iso-butyl methacrylate, iso-octyl acrylate, iso-octyl methacrylate, cyclohexyl acrylate, cyclohexyl methacrylate, glycidyl acrylate, glycidyl methacrylate, hydroxyethyl acrylate, hydroxypropyl acrylate, 2-hydroxyethyl acrylate, 2-hydroxyethyl methacrylate, 2-hydroxypropyl acrylate, 2-hydroxypropyl methacrylate. and hydroxypropyl methacrylate and a mixture thereof, among which acrylic acid. methacrylic acid, methyl acrylate, methyl methacrylate, butyl acrylate, butyl methacrylate, iso-butyl acrylate, iso-butyl methacrylate, hydroxyethyl acrylate, 2-hydroxyethyl acrylate, 2-hydroxyethyl methacrylate, 2-hydroxypropyl acrylate, and 2-hydroxypropyl methacrylate, and a mixture thereof are preferred.

Preferred are polyacrylic acids, (C₃H₄O₂)ₙ or 2-Propenoic acid homopolymers; Acrylic acid polymer; Poly(acrylic acid); Propenoic acid polymer; PAA have the following structural formula:

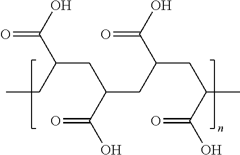

where n is any integer.

One source of commercially available polyacrylates (polyacrylic acid homopolymers) useful for the invention includes the Acusol 445 series from The Dow Chemical Company, Wilmington Delaware, USA, including, for example, Acusol® 445 (acrylic acid polymer, 48% total solids) (4500 MW), Acusol® 445N (sodium acrylate homopolymer, 45% total solids)(4500 MW), and Acusol®445ND (powdered sodium acrylate homopolymer, 93% total solids)(4500 MW) Other polyacrylates (polyacrylic acid homopolymers) commercially available from Dow Chemical Company suitable for the invention include, but are not limited to Acusol 929 (10,000 MW) and Acumer 1510. Yet another example of a commercially available polyacrylic acid is AQUATREAT AR-6 (100,000 MW) from AkzoNobel Strawinskylaan 2555 1077 ZZ Amsterdam Postbus 75730 1070 AS Amsterdam. Other suitable polyacrylates (polyacrylic acid homopolymers) for use in the invention include, but are not limited to those obtained from additional suppliers such as Aldrich Chemicals, Milwaukee, Wis., and ACROS Organics and Fine Chemicals, Pittsburg, Pa, BASF Corporation and SNF Inc.

The water conditioning polymer(s), such as polyacrylic acid homopolymer can be included in the acidic rinse aid compositions from about 1 to about 40 wt-%, about 1 to about 15 wt-%, or about 1 to about 10 wt-%. In addition, without being limited according to the disclosure, all ranges recited are inclusive of the numbers defining the range and include each integer within the defined range.

### Preservatives

The acidic rinse aid composition can also include an effective amount of a preservative. Often, overall acidity and/or acids in the composition can provide a preservative and stabilizing function. Some embodiments of the acidic rinse aid composition also include a GRAS preservative system for acidification of the composition including sodium bisulfate and organic acids. In some embodiments, sodium bisulfate is included in the acidic rinse aid composition as an acid source as well. In other embodiments, an effective amount of sodium bisulfate and one or more other acid sources are included in the rinse aid composition as a preservative system. Suitable acids include for example, inorganic acids, such as HCl and organic acids, such as citric, lactic, acetic, formic, and/or hydroxyacetic acid. In certain further embodiments, an effective amount of sodium bisulfate and one or more organic acids are included in the acidic rinse aid composition as a preservative system. Generally, effective amounts of sodium bisulfate with or without additional acids are included such that a use solution of the acidic rinse aid composition has a pH less than about pH 6.0, and preferably less than about pH 5.5.

Preferred preservatives for use in the acidic rinse aid compositions include, methylchloroisothiazolinone, methylisothiazolinone, or a blend of the same. A blend of methylchloroisothiazolinone and methylisothiazolinone is available from Dow Chemical under the trade name KATHON™ CG. Additional preferred preservatives include salts of pyrithione, including, for example sodium pyrithione.

When a preservative is included in the acidic rinse aid compositions, it can be present from about 0.01 to about 5 wt-%, from about 0.05 to about 3 wt-%, or from about 0.1 to about 1 wt-%. In addition, without being limited according to the disclosure, all ranges recited are inclusive of the numbers defining the range and include each integer within the defined range.

### Chelant

The acidic rinse aid compositions may also include effective amounts of chelants (or sequestering agents or builders) as an additional functional ingredient. In general, a chelant or chelating agent, used synonymously herein, is a molecule capable of coordinating (i.e., binding) metal ions commonly found in water sources to prevent the metal ions from interfering with the action of the other ingredients of a rinse aid composition. The chelant may also function as a water conditioning agent when included in an effective amount. In some embodiments, an acidic rinse aid composition can include in the range of up to about 50 wt-%, or in the range of about 1 to about 50 wt-% of a chelant. In addition, without being limited according to the disclosure, all ranges recited are inclusive of the numbers defining the range and include each integer within the defined range.

In embodiments, the acidic rinse aid composition is also phosphate-free and/or sulfate-free. In embodiments of the acidic rinse aid composition that are phosphate-free, the additional functional materials, including chelants exclude phosphorous-containing compounds such as condensed phosphates and phosphonates.

Suitable chelants include aminocarboxylates and polycarboxylates. Some examples of aminocarboxylates useful as chelating/sequestering agents, include, N-hydroxyethyliminodiacetic acid, nitrilotriacetic acid (NTA), ethylenediaminetetraacetic acid (EDTA), N-hydroxyethyl-ethylenediaminetriacetic acid (HEDTA) (in addition to the HEDTA used in the binder), diethylenetriaminepentaacetic acid (DTPA), and the like. Some examples of polymeric polycarboxylates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

In embodiments of the acidic rinse aid composition which are not phosphate-free, added chelants may include, for example a condensed phosphate, a phosphonate, and the like. Some examples of condensed phosphates include sodium and potassium orthophosphate, sodium and potassium pyrophosphate, sodium tripolyphosphate, sodium hexametaphosphate, and the like. A condensed phosphate may also assist, to a limited extent, in solidification of the composition by fixing the free water present in the composition as water of hydration.

In embodiments of the acidic rinse aid composition which are not phosphate-free, the composition may include a phosphonate such as 1-hydroxyethane-1,1-diphosphonic acid CH₃C(OH)[PO(OH)₂]₂; aminotri(methylenephosphonic acid) N[CH₂PO(OH)₂]₃; aminotri(methylenephosphonate), sodium salt, such as:

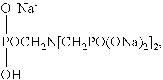

2-hydroxyethyliminobis(methylenephosphonic acid) HOCH₂CH₂N[CH₂PO(OH)₂]₂; diethylenetriaminepenta(methylenephosphonic acid) (HO)₂ POCH₂N[CH₂CH₂N[CH₂PO(OH)₂]₂]₂; diethylenetriaminepenta(methylenephosphonate), sodium salt C₉ H₍₂₈₋ₓ₎N₃NaₓO₁₅P₅ (x=7); examethylenediamine(tetramethylenephosphonate), potassium salt C₁₀H₍₂₈₋ₓ₎N₂KₓO₁₂P₄ (x=6); bis(hexamethylene)triamine(pentamethylenephosphonic acid)(HO₂)POCH₂N[(CH₂)₆ N[CH₂ PO(OH)₂]₂]₂; and phosphorus acid H₃PO3. In some embodiments, a phosphonate combination such as ATMP and DTPMP may be used. A neutralized or alkaline phosphonate, or a combination of the phosphonate with an alkali source prior to being added into the mixture such that there is little or no heat or gas generated by a neutralization reaction when the phosphonate is added can be used.

For a further discussion of chelants, see Kirk-Othmer, Encyclopedia of Chemical Technology, Third Edition, volume 5, pages 339-366 and volume 23, pages 319-320, the disclosure of which is incorporated by reference herein.

### Functional Polydimethylsiloxones

The acidic rinse aid composition can also optionally include one or more functional polydimethylsiloxones. For example, in some embodiments, a polyalkylene oxide-modified polydimethylsiloxane, nonionic surfactant or a polybetaine-modified polysiloxane amphoteric surfactant can be employed as an additive. Both, in some embodiments, are linear polysiloxane copolymers to which polyethers or polybetaines have been grafted through a hydrosilation reaction. Some examples of specific siloxane surfactants are known as SILWET® surfactants available from Union Carbide or ABIL® polyether or polybetaine polysiloxane copolymers available from Goldschmidt Chemical Corp., and described in U.S. Pat. No. 4,654,161 which patent is incorporated herein by reference. In some embodiments, the particular siloxanes used can be described as having, e.g., low surface tension, high wetting ability and excellent lubricity. For example, these surfactants are said to be among the few capable of wetting polytetrafluoroethylene surfaces. The siloxane surfactant employed as an additive can be used alone or in combination with a fluorochemical surfactant. In some embodiments, the fluorochemical surfactant employed as an additive optionally in combination with a silane, can be, for example, a nonionic fluorohydrocarbon, for example, fluorinated alkyl polyoxyethylene ethanols, fluorinated alkyl alkoxylate and fluorinated alkyl esters.

Further description of such functional polydimethylsiloxones and/or fluorochemical surfactants are described in U.S. Pat. Nos. 5,880,088; 5,880,089; and 5,603,776, all of which patents are incorporated herein by reference. In some embodiments, the use of the polysiloxane copolymers in combination with the rinse aid surfactants provides excellent rinse aids on plastic ware. In some embodiments, the use of silicone polysiloxane copolymers and fluorocarbon surfactants with conventional hydrocarbon surfactants also provide excellent rinse aids on plastic ware. Therefore, some embodiments encompass the polysiloxane copolymers alone and the combination with the fluorocarbon surfactant can involve polyether polysiloxanes, the nonionic siloxane surfactants. The amphoteric siloxane surfactants, the polybetaine polysiloxane copolymers may be employed alone as the additive in the rinse aids to provide the same results.

In some embodiments, the composition may include functional polydimethylsiloxones in an amount in the range of up to about 10 wt-%. For example, some embodiments may include in the range of about 0.1 to 10 wt-% of a polyalkylene oxide-modified polydimethylsiloxane or a polybetaine-modified polysiloxane, optionally in combination with about 0.1 to 10 wt-% of a fluorinated hydrocarbon nonionic surfactant. In addition, without being limited according to the disclosure, all ranges recited are inclusive of the numbers defining the range and include each integer within the defined range.

### EMBODIMENTS

The present disclosure is further defined by the following numbered paragraphs:

A method of rinsing a surface with a rinse aid composition comprising: providing an acidic rinse aid composition to a surface, wherein the acidic rinse aid composition comprises at least one acid source, at least one rinse aid surfactant, and at least one solidification aid and/or water, wherein the composition is a solid or liquid; and rinsing said acidic rinse aid composition from said surface, wherein said acidic rinse aid composition has a use solution pH less than about 6 and provides cleaning efficacy on the surface.

The method of paragraph 1, wherein the use solution pH is less than about 5.5, or less than about 5.

The method of any one of paragraphs 1-2, wherein carbonate in water is neutralized and converted to carbonic acid to aid in cleaning during the rinse step.

The method of any one of paragraphs 1-3, further comprising an initial step of generating a use solution of the acidic rinse aid composition.

The method of any one of paragraphs 1-4, wherein the rinsing of said acidic rinse aid composition follows a cleaning step.

The method of paragraph 5, wherein the cleaning step comprises a caustic detergent, carbonate detergent, silicate detergent, tripoly detergent, enzymatic detergent or combinations thereof.

The method of any one of paragraphs 1-6, wherein a water source is employed, e.g. from 0 gpg to about 17 gpg.

The method of any one of paragraphs 1-6, wherein a softened water source is employed.

The method of any one of paragraphs 1-8, wherein the methods do not cause carbonate precipitation and/or film formation.

The method of any one of paragraphs 1-9, wherein the surface is a ware.

The method of paragraph 10, wherein the ware is rinsed in a commercial or consumer warewash machine.

An acidic rinse aid composition comprising: at least one acid source; at least one rinse aid surfactant; and at least one solidification aid and/or water, wherein the composition is a solid or liquid.

The composition of paragraph 14, wherein the acid source comprises an organic acid and/or inorganic acid.

The composition of any one of paragraphs 14-15, wherein the acid source comprises from about 1 wt-% to about 90 wt-%, from about 10 wt-% to about 90 wt-%, or from about 20 wt-% to about 60 wt-% of the composition.

The composition of any one of paragraphs 14-16, wherein the rinse aid surfactant comprises one or more alcohol alkoxylate compounds, alcohol ethoxylate compounds, polyether compounds, block polyoxypropylene-polyoxyethylene polymeric compounds, additional nonionic surfactants and/or polymer surfactants, or combinations thereof.

The composition of any one of paragraphs 14-17, wherein the rinse aid surfactant comprises from about 1 wt-% to about 50 wt-%, from about 5 wt-% to about 30 wt-%, or about 5 wt-% to about 20 wt-% of the composition.

The composition of any one of paragraphs 14-18, further comprising water and/or a solidification agent.

The composition of any one of paragraphs 14-19, further comprising an antiredeposition agent, defoamer, water conditioning polymer, preservative, humectants, sanitizing agents, anti-microbial agents, chelant, enzyme, rheology modifier, dispersant, or combinations thereof.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

Exemplary acidic rinse aid compositions comprising citric acid were prepared according to Table 2 to evaluate varying concentration levels of the citric acid (from 50 ppm to 300 ppm based on a 2 ml/rack dosing rate for dispensing in a ware wash machine). The citric acid rinse aid compositions of Table 1 were tested for cleaning ability. The acidic rinse aid compositions were analyzed under a 10-cycle test utilizing 5 gpg water.

TABLE 2

| | CA50 | CA75 | CA100 | CA125 | CA150 | CA200 | CA250 | CA300 |
|---|---|---|---|---|---|---|---|---|
| Description | wt % | wt % | wt % | wt % | wt % | wt % | wt % | wt % |
| Citric Acid, | 14.00 | 21.00 | 28.00 | 35.00 | 42.00 | 56.00 | 70.00 | 84.00 |
| 50% | | | | | | | | |
| Plurafac | 4.50 | 4.50 | 4.50 | 4.50 | 4.50 | 4.50 | 4.50 | 4.50 |
| RA300 | | | | | | | | |
| Plurafac | 2.50 | 2.50 | 2.50 | 2.50 | 2.50 | 2.50 | 2.50 | 2.50 |
| SLF180 | | | | | | | | |
| DI Water | 79.00 | 72.00 | 65.00 | 58.00 | 51.00 | 37.00 | 23.00 | 9.00 |
| ppm CA | 50.0 | 75.0 | 100.0 | 125.0 | 150.0 | 200.0 | 250.0 | 300.0 |

10-cycle film evaluation was conducted according to the following methods.

6 Tiles were placed in a rack in a diagonal line. A Hobart AM15 machine was charged with 1000 ppm of a commercially-available liquid caustic detergent and 2 mL/rack of each citric acid rinse aid composition evaluated. The detergent remained the same for each acidic rinse aid composition evaluated. A concentration of 0.2% (2000 ppm) food soil was added to the machine (accounting for volume of sump). 5 gpg (grain per gallon, water hardness measurement) water was used in the machine. When the test started, the detergent and rinse aid dispensers automatically dosed the described amounts each cycle. The wash cycle was run at 160° F., and the rinse cycle was run at 180° F. The detergent was controlled by conductivity and the acidic rinse aid composition was dispensed in milliliters per rack. The food soil was hand dosed for each cycle to maintain 0.2% (2000 ppm) concentration. When the test was finished, the tiles were allowed to dry overnight and evaluated for film accumulation. Tiles were then stained with Coomassie blue to determine protein residue.

The cleaning performance of the acidic rinse aid composition was analyzed using dyed tile and glass samples. FIG. 1 illustrates sample tiles showing very good performance with completely white tiles to very bad performance with completely stained blue tiles. Tiles are rated from very good (rating of 1) to very bad (rating of 5).

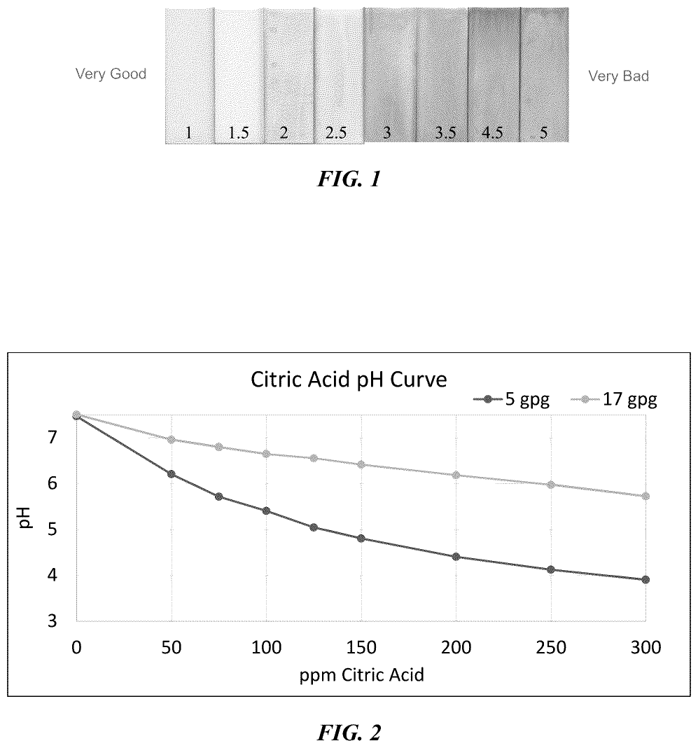

The results of the 10-cycle (5 gpg curve) are tabulated in Table 3 and visually shown in FIG. 2. As FIG. 2 illustrates, the water hardness, or natural alkalinity of the water, impacts the pH of the acidic rinse aid compositions. As the amount of citric acid increased, the pH was lowered in the 5 gpg water.

TABLE 3

| | | | 2 mL/ | pH curve | |
|---|---|---|---|---|---|
| Description | wt % | ppm | rack | 5gpg | 17gpg |
| Citric Acid, 50% | 0 | | 0 | 7.46 | 7.5 |
| Citric Acid, 50% | 14.00 | | 50 | 6.20 | 6.95 |
| Citric Acid, 50% | 21.00 | | 75 | 5.71 | 6.79 |
| Citric Acid, 50% | 28.00 | | 100 | 5.4 | 6.64 |
| Citric Acid, 50% | 35.00 | | 125 | 5.04 | 6.55 |
| Citric Acid, 50% | 42.00 | | 150 | 4.8 | 6.41 |
| Citric Acid, 50% | 56.00 | | 200 | 4.4 | 6.18 |
| Citric Acid, 50% | 70.00 | | 250 | 4.12 | 5.97 |
| Citric Acid, 50% | 84.00 | | 300 | 3.9 | 5.72 |

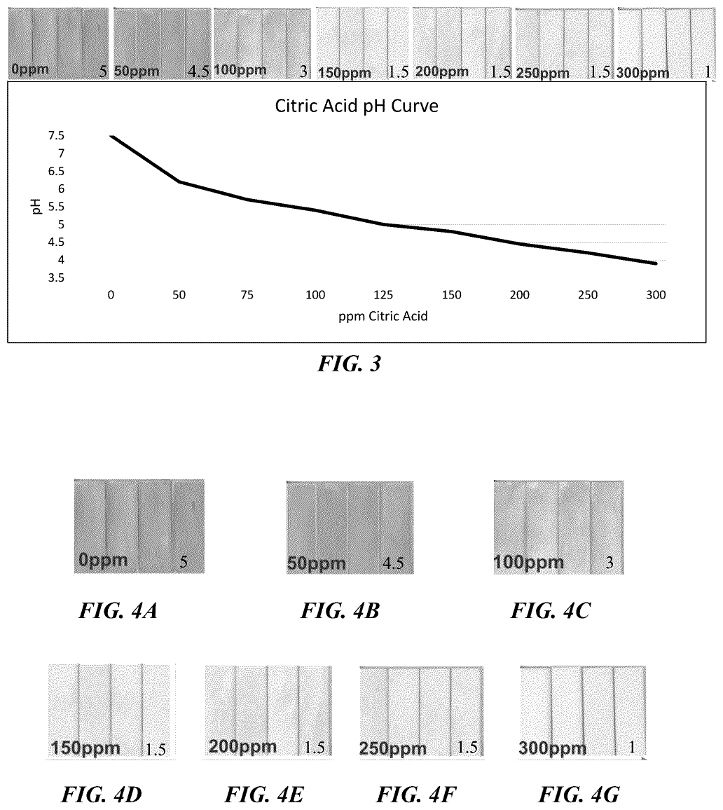

FIG. 3 shows the cleaning performance of the acidic rinse aid compositions of Table 1. The 10-cycle film evaluation of the acidic rinse aid compositions of Table 1 and FIG. 2 is shown in FIG. 3 along with the photos of the stained tile samples. FIGS. 4A-4G show the stained tile samples of FIG. 3 that were rinsed with the acidic rinse aid compositions of Table 1. The stained tile samples shown in FIGS. 3 and 4A-4G are rated according to the scale of performance as previously shown in FIG. 1. FIGS. 3 and 4A-4G show the improved cleaning performance of the higher concentrations of citric acid. Moreover, the tile samples that were washed with a solution with a pH of below 5.5 (approximately 100 ppm citric acid) show a vast increase in cleaning performance and have very little blue stain remaining on the tile samples.

### Example 2

Acidic rinse aid compositions comprising citric acid were prepared according to Table 2 to evaluate varying concentration levels of the citric acid (from 50 ppm to 300 ppm based on a 2 ml/rack dosing rate for dispensing in a ware wash machine). The citric acid rinse aid compositions of Table 1 were tested for cleaning ability. The acidic rinse aid compositions were analyzed under a 100-cycle test utilizing 17 gpg water.

100-cycle film evaluation was conducted according to the following methods:

6 Glasses were placed in a rack in a diagonal line. The machine was charged 1000 ppm of a commercially-available liquid caustic detergent and 2 mL/rack of each citric acid rinse aid composition evaluated. The detergent remained the same for each acidic rinse aid composition evaluated. No food soil was added to the machine. The water used in the machine was 17 gpg water. When the test started, the detergent and rinse aid dispensers automatically dosed the described amounts each cycle. The wash cycle was run at 160° F., and the rinse cycle was run at 180° F. The detergent was controlled by conductivity and the acidic rinse aid composition was dispensed in milliliters per rack. When the test was finished, the glasses were allowed to dry overnight and evaluated for film accumulation. The glasses were then stained with Coomassie blue to determine protein residue.

The results of the 10-cycle (5 gpg curve) and 100-cycle (17 gpg curve) are tabulated in Table 3 and visually shown in FIG. 2. As FIG. 2 illustrates, the water hardness, or natural alkalinity of the water, impacts the pH of the acidic rinse aid compositions. As the amount of citric acid increased, the pH lowered in both the 5 gpg and 17 gpg water. Yet, the overall pH was decreased by a lower amount in the 17 gpg water compared to the 5 gpg water, which is due to the higher alkalinity of the water impacting and interacting with the citric acid.

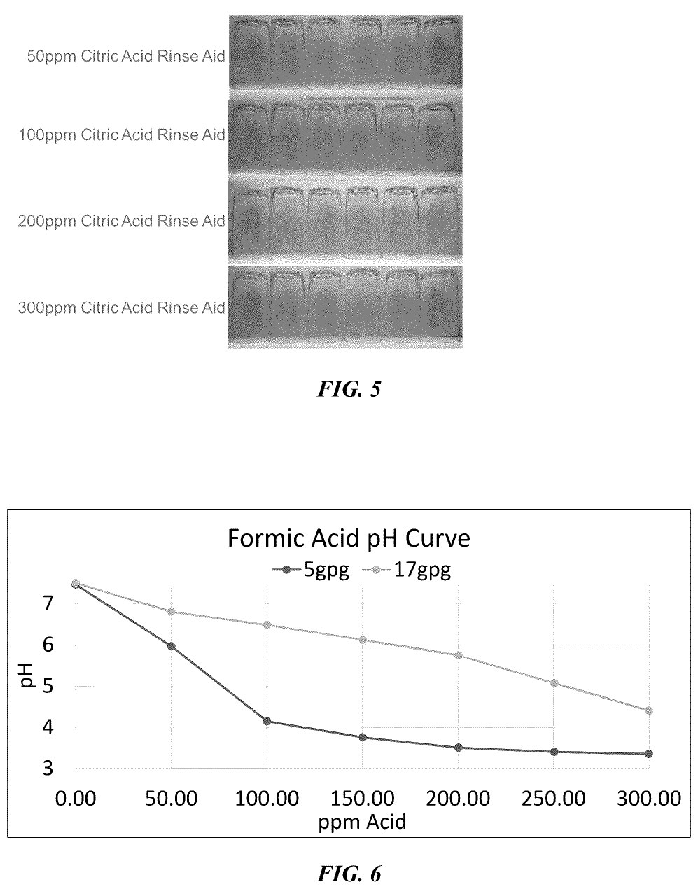

FIG. 5 shows the cleaning performance of the acidic rinse aid compositions of Table 1. FIG. 5 shows the glass samples of the 100-cycle film evaluation that were rinsed with the acidic rinse aid compositions of Table 1. Again, as can be seen by FIG. 5, the acidic rinse aid compositions greatly improved the cleaning performance of the glasses, with even 50 ppm of citric acid showing little to no blue stain remaining on the glass samples.

### Example 3

Acidic rinse aid compositions comprising formic acid were prepared according to Table 4 to evaluate varying concentration levels of the formic acid (from 50 ppm to 300 ppm based on a 2 mL/rack dosing rate for dispensing in a ware wash machine). The acidic rinse aid compositions of Table 3 were tested for cleaning ability. The acidic rinse aid compositions were analyzed under a 10-cycle test utilizing 5 gpg water and a 100-cycle test utilizing 17 gpg water, as described in Examples 1 and 2.

The results of the 10-cycle (5 gpg curve) and 100-cycle (17 gpg curve) are tabulated in Table 5 and visually shown in FIG. 6. As FIG. 6 illustrates, the water hardness, or natural alkalinity of the water, impacts the pH of the acidic rinse aid compositions. As the amount of formic acid increased, the pH lowered in both the 5 gpg and 17 gpg water, much like the citric acid rinse aid compositions of Examples 1 and 2.

TABLE 4

| | FA50 | FA100 | FA150 | FA200 |
|---|---|---|---|---|
| Description | wt % | wt % | wt % | wt % |
| Formic Acid, 85% | 8.25 | 16.50 | 24.75 | 33.00 |
| Plurafac RA300 | 4.50 | 4.50 | 4.50 | 4.50 |
| Plurafac SLF180 | 2.50 | 2.50 | 2.50 | 2.50 |
| DI Water | 84.75 | 76.50 | 68.25 | 60.00 |
| ppm FA | 50.1 | 100.2 | 150.3 | 200.4 |

TABLE 5

| | | | 2 mL/ | pH curve | |
|---|---|---|---|---|---|
| Description | wt % | ppm | rack | 5gpg | 17gpg |
| Formic Acid, 85% | 0.00 | | 0.00 | 7.46 | 7.5 |
| Formic Acid, 85% | 8.25 | | 50.09 | 5.96 | 6.8 |
| Formic Acid, 85% | 16.50 | | 100.18 | 4.14 | 6.48 |
| Formic Acid, 85% | 24.75 | | 150.27 | 3.75 | 6.12 |
| Formic Acid, 85% | 33.00 | | 200.36 | 3.50 | 5.74 |
| Formic Acid, 85% | 41.25 | | 250.45 | 3.4 | 5.07 |
| Formic Acid, 85% | 49.41 | | 299.99 | 3.35 | 4.4 |

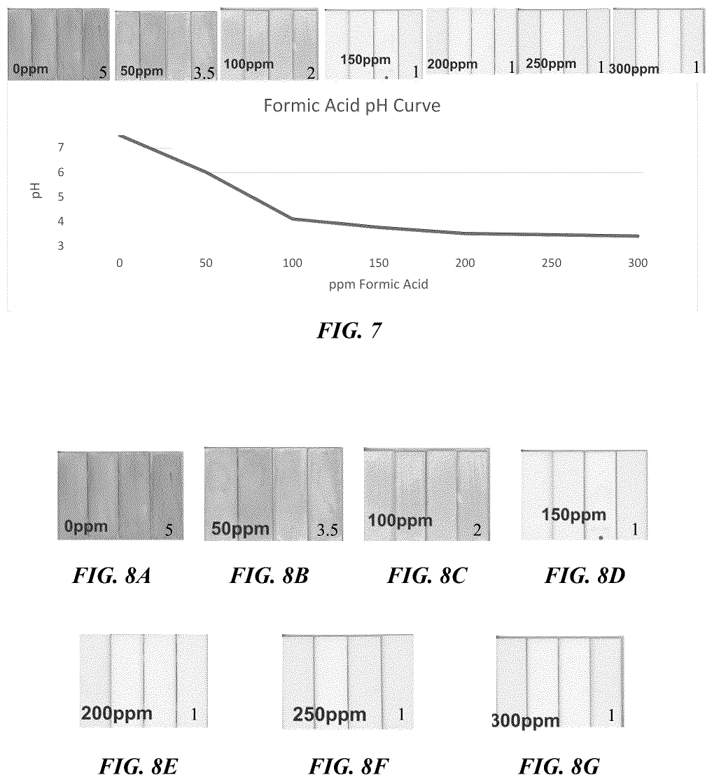

FIG. 7 shows the cleaning performance of the acidic rinse aid compositions of Table 3. The 10-cycle film evaluation of the acidic rinse aid compositions of Table 4 and FIG. 6 is shown in FIG. 7 along with the photos of the stained tile samples. FIGS. 8A-8G show the stained tile samples of FIG. 7 that were rinsed with the acidic rinse aid compositions of Table 4. The stained tile samples shown in FIGS. 7 and 8A-8G are rated according to the scale of performance as previously shown in FIG. 1. FIGS. 7 and 8A-8G show the improved cleaning performance of the higher concentrations of formic acid, much like the results of the citric acid rinse aid compositions. Moreover, the tile samples that were washed with a solution with a pH of below 4.5 (approximately 100 ppm formic acid) show an increase in cleaning performance with the acidic rinse aid composition with a pH of below 4 having very little blue stain remaining on the tile samples.

### Example 4

The 300 ppm citric acid rinse aid composition of Table 2 was compared to a commercially-available neutral rinse aid and evaluated using a 10-cycle cleaning test to determine the cleaning performance. 10-cycle film evaluation was conducted according to the methods of Example 1. The machine was charged with 750 ppm of a solid ash-based detergent and 2 mL of a 300 ppm citric acid rinse aid composition or 2 mL of a neutral rinse aid.

The improved cleaning performance of the neutral rinse aid composition compared to the citric acid rinse aid composition can be seen in FIGS. 9A and 9B, respectfully. As shown in these figures, the stained tile samples utilizing the neutral rinse aid have significant blue dye remaining, yet the acidic rinse aid composition tile samples are completely white with no remaining blue dye. These figures show that when used with a solid ash-based detergent, unlike the liquid caustic detergent used in Example 1, the acidic rinse aid composition still significantly improves the cleaning performance when compared to a neutral rinse aid.

### Example 5

Additional testing with the acidic rinse aid composition CA200 (shown in Table 2) was conducted to confirm there is no detrimental impact of dry time with the use of the acidic pH in the use solution. The acidic rinse aid composition was compared to water and a neutral rinse aid alone and with caustic detergents to show improvements in rinse dry time. The following test conditions were employed:
Machine: Hobart AM15 machine (2.8 L rinse & 56 L sump)
Wash temp: 160° F.
Rinse temp: 180° F.
Detergent: 1000 ppm commercially available caustic detergent
Cycles run: 1 cycle
Rinse aid/Water concentration: 2 mL

FIG. 10 demonstrates that when the acidic rinse aid composition is utilized alone, or in combination with a caustic detergent, the water retention—a measurement of dry time—was significantly reduced.

### Example 6

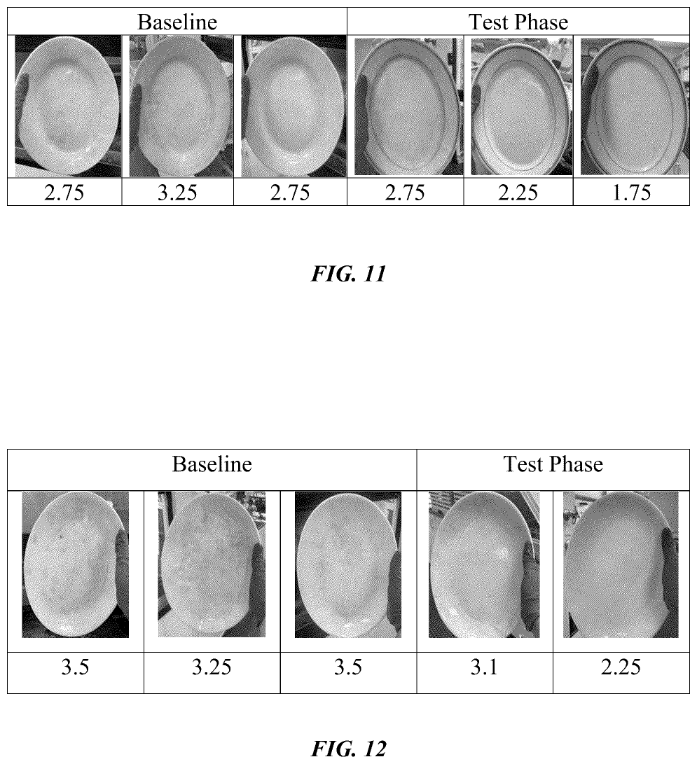

Cleaning efficacy of the acidic rinse aid composition shown in Table 2 as CA200 in combination with a caustic detergent was tested on porcelain dinner plates. The dinner plates were placed in a ES2000HT Machine 5.6 L Rinse dishwashing machine rack. To determine a baseline to compare the caustic detergent and acidic rinse aid composition, the dinner plates were washed with 1000 ppm of a 10.5 pH commercially-available caustic detergent. No food soil was added to the machine. The water used in the machine was 5 gpg water. The wash cycle was run at 160° F., and the rinse cycle was run at 180° F. When the test was finished, the dinner plates were allowed to dry and were then stained with Coomassie blue to determine protein residue. FIG. 11 visually shows that the baseline (without rinse aid inclusion) of the dinner plates showed significant blue staining, or protein, left on the plates initially and after 1 recovery cycle, with only the third plate after 3 recovery cycles showing an improvement in protein removal.

Similar to the baseline procedures described above, the machine was charged 1000 ppm of a 9.5 pH commercially-available liquid caustic detergent and 2 mL per rack of the acidic rinse aid composition shown in Table 2 as CA200 with a pH of approximately 5.0. No food soil was added to the machine. The water used in the machine was 5 gpg water. The wash cycle was run at 160° F., and the rinse cycle was run at 180° F. When the test was finished, the dinner plates were allowed to dry and were then stained with Coomassic blue to determine protein residue. FIG. 11 shows that the dinner plates washed with the acidic rinse aid composition, in addition to a caustic detergent, show an overall improved cleaning efficacy immediately, with the last plate showing little to no remaining blue stained protein.

### Example 7

Similar to Example 6, cleaning efficacy of the acidic rinse aid composition shown in Table 2 as CA200 in combination with a caustic detergent was tested on porcelain dinner plates in 0-1 gpg water. The dinner plates were placed in a ES2000HT Machine 5.6 L Rinse dishwashing machine rack. To determine a baseline to compare the caustic detergent and acidic rinse aid composition, the dinner plates were washed with 1000 ppm of a 10.5 pH commercially-available caustic detergent. No food soil was added to the machine. The water used in the machine was 0-1 gpg water. The wash cycle was run at 160° F., and the rinse cycle was run at 180° F. When the test was finished, the dinner plates were allowed to dry and were then stained with Coomassie blue to determine protein residue. FIG. 12 visually shows that the baseline (without rinse aid inclusion) of the dinner plates showed significant blue staining, or protein, left on the plates initially, after 1 recovery cycle, and after 3 recovery cycles, with all of the plates showing a similar amount of protein remaining.

Similar to the baseline procedures described above and in Example 6, the machine was charged 1000 ppm of a 9-10 pH commercially-available liquid caustic detergent and 5 mL per rack of the acidic rinse aid composition with a pH of approximately 5.5. No food soil was added to the machine. The water used in the machine was 0-1 gpg water. The wash cycle was run at 160° F., and the rinse cycle was run at 180° F. When the test was finished, the dinner plates were allowed to dry and were then stained with Coomassie blue to determine protein residue.

FIG. 12 shows that the dinner plates washed with the acidic rinse aid composition, in addition to a caustic detergent, show an overall improved cleaning efficacy immediately, with the last plate showing little to no remaining blue stained protein.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A method of rinsing a surface with a rinse aid composition comprising:
providing an acidic rinse aid composition to a surface, wherein the acidic rinse aid composition comprises at least one acid source, at least one rinse aid surfactant, and at least one solidification aid and/or water, wherein the composition is a solid or liquid; and
rinsing said acidic rinse aid composition from said surface with a water source,
wherein said acidic rinse aid composition has a use solution pH less than about 6, to aid in cleaning efficacy on the surface during the rinse step.

2. The method of claim 1, wherein the use solution pH is less than about 5.5.

3. The method of claim 1, further comprising an initial step of generating a use solution of the acidic rinse aid composition, and wherein the use solution comprises at least about 50 ppm of the acidic rinse aid composition.

4. The method of claim 1, wherein the rinsing of said acidic rinse aid composition follows a cleaning step.

5. The method of claim 4, wherein the cleaning step comprises a caustic detergent, carbonate detergent, silicate detergent, tripoly detergent, enzymatic detergent or combinations thereof.

6. The method of claim 1, wherein the water source from 0 gpg to about 17 gpg.

7. The method of claim 1, wherein the water source is a softened water source.

8. The method of claim 1, wherein the methods do not cause carbonate precipitation and/or film formation.

9. The method of claim 1, wherein the surface is a ware.

10. The method of claim 9, wherein the ware is rinsed in a commercial or consumer warewash machine.

11. An acidic rinse aid composition comprising:
at least one acid source;
at least one rinse aid surfactant; and
at least one solidification aid and/or water,
wherein the composition is a solid or liquid,
wherein a use solution of the composition has a pH less than about 6.

12. The composition of claim 11, wherein the acid source comprises an organic acid and/or inorganic acid.

13. The composition of claim 11, wherein the acid source comprises from about 1 wt-% to about 90 wt-%of the composition.

14. The composition of claim 11, wherein the rinse aid surfactant comprises one or more alcohol alkoxylate compounds, alcohol ethoxylate compounds, polyether compounds, block polyoxypropylene-polyoxyethylene polymeric compounds, alkylpoly glucoside, additional nonionic surfactants and/or polymer surfactants, or combinations thereof.

15. The composition of claim 11, wherein the rinse aid surfactant comprises from about 1 wt-% to about 50 wt-% of the composition.

16. The composition of claim 11, further comprising water and/or a solidification agent.

17. The composition of claim 11, further comprising an antiredeposition agent, defoamer, water conditioning polymer, preservative, humectants, sanitizing agents, anti-microbial agents, chelant, enzyme, rheology modifier, dispersant, or combinations thereof.

18. The composition of claim 11, wherein the composition is free of zinc and/or zinc salts.

19. The composition of claim 11. wherein the use solution of the composition has a pH less than about 5.5.

20. The composition of claim 19. wherein the use solution of the composition has a pH less than about 5.
